(19) United States
(12) Patent Application Publication
(10) Pub. No.: US 2016/0034772 A1
(43) Pub. Date: Feb. 4, 2016

(54) METHOD AND APPARATUS FOR ACQUIRING BIOMETRIC IMAGE

(71) Applicants: Ellis I. BETENSKY, Etobicoke (CA); William T. PLUMMER, Concord, MA (US); Richard N. YOUNGSWORTH, Boise, ID (US)

(72) Inventors: Ellis I. Betensky, Etobicoke (CA); William T. Plummer, Concord, MA (US); Richard N. Youngworth, Boise, ID (US)

(21) Appl. No.: 14/775,705

(22) PCT Filed: Mar. 13, 2014
(86) PCT No.: PCT/US14/26797

§ 371 Date: Sep. 13, 2015

Related U.S. Application Data
(60) Provisional application No. 61/788,670, filed on Mar. 15, 2013.

(51) Int. Cl. G06K 9/00; H04N 5/225; H04N 5/232

(52) U.S. Cl. CPC G06K 9/00892; H04N 5/23229; H04N 5/2256; G06K 9/00087; G06K 9/0004

(57) ABSTRACT

A compact and inexpensive method and apparatus for illuminating and acquiring a digital image of a biometric feature such as a fingerprint, palm print, footprint, or some subset or multiple of such features. A source of illumination (11) is introduced into an exposed edge of a transparent optical window (13) that is essentially smooth and generally flat with spaced apart surfaces. The illumination propagates between the surfaces of a flat or slightly curved transparent window (13) via total internal reflection (15) to obliquely illuminate a biometric feature (12) when in contact with the window (13). A digital camera (17) views the obliquely illuminated biometric feature (12) to record an image of it which can then be compared with registered images for matching and control purposes.

The invention, in general, relates to digital acquisition of images and, in particular, to the acquisition of images of biometric features such as fingerprints and the like.

Prior art includes transferring a thin layer of ink onto a finger pad surface and touching a blank sheet of paper to form an image of the ridges and spaces that constitute a fingerprint image. That classic art is both slow and messy.

Prior art also includes an inkless technique that contacts the finger pad onto a prism face where total internal reflection takes place, such that reflection is lost where the ridges of the finger are against the prism surface, forming a dark image of each ridge. For this purpose the incident light is preferably collimated before and after the reflection, so that all of the light is incident on the touched surface at about the same angle, and is therefore equally sensitive to the presence of the finger ridges. Collimated light reflected by the prism face is received efficiently by the pupil of an image-forming lens, so that the prism face is bright except where finger ridges contact it and destroy the total reflection. This mode of operation has been called “brightfield illumination”.

Prior art includes at least one example of “darkfield illumination”, by which the collimated incident light is eliminated, but the viewing angle remains as before. The image-forming lens sees a total reflection only of the distant prism face, preferably painted black. Diffuse illumination is provided to illuminate the finger pad more or less directly through the contact prism face, without total reflection. Where the finger ridges contact the prism the light scattered from them is partially received by the image-forming lens, which detects bright ridges on a dark background. Although the image-forming optical path remains the same as in the brightfield case, the apparatus is smaller and less expensive because the provision for collimating the incident light is eliminated and because one less prism face requires an optical polish.

Clark, P. P., D. S. Goodman, and W. T. Plummer, “Compact Finger Imager”, SPIE 3789, Current Developments in Optical Design & Optical Engineering VIII, 7 pp. (July 1999) defines the terms used above and also illustrates a number of optical problems that were solved in an apparatus introduced by Polaroid.

Additional known prior art for the optical reading of fingerprints includes a thin and flat microprism plate introduced by the Identicator Corporation (U.S. Pat. Nos. 5,732,148 and 6,069,969). This is merely another brightfield method, but it replaces one large prism with an array of little ones. It still requires full-field collimated illumination, telecentric imaging at the finger, and provisions for dealing with field tilt and anamorphic distortion. In addition, the microprism structure is nearly in focus along with the finger structure and must be well-made to avoid the introduction of extraneous features.

Prior inkless art still leaves room for improvement because the prism used is a comparatively large and expensive optical part. The oblique view of the finger area suffers both field tilt and anamorphic distortion by foreshortening, a problem that must be solved by special optical components, special geometry, and perhaps even a special digital sensor that has unequal pixel spacing in its two axes, all illustrated in the Clark reference.

Prior art related to the statement about our lack of holographic or microprism structure on the flat plate is covered by U.S. Pat. Nos. 5,732,148; 6,069,969; and 7,728,959. The surface hologram is a set of microscopic prisms. The first two patents both use parallel rule microprisms covering the surface of a flat plate, while the third uses a holographic structure on a flat plate.

There are further more expensive methods, often used for identification and not access control, such as using biometric identification with tissue as well as touchless fingerprint sensing. Touchless methods often utilize structured light to scan fingerprints and then sensing return light. Such methods can provide high resolution fingerprint identification methods, but are more costly and complex than the invention for access control discussed here.

A method and apparatus is provided for acquiring a digital image of a biometric feature such as a fingerprint, palm print, footprint, or some subset or multiple of such features. A source of illumination is introduced into an exposed edge of a transparent optical window that is essentially smooth and generally flat formed by spaced apart surfaces. The illumination propagates between the surfaces of the window via total internal reflection to obliquely illuminate a biometric feature when in contact with the window. A digital camera views the obliquely illuminated biometric feature to record an image of it which can then be compared with registered images for matching and control purposes.

The apparatus comprises a transparent optical window having generally spaced apart smooth surfaces and at least one exposed edge formed between said surfaces. A source, preferably one or more LEDs, is provided for introducing radiation into the transparent optical window through the exposed edge so that the radiation coupled through the exposed edge propagates between the spaced apart surfaces by total internal reflection to obliquely illuminate a biometric feature when brought into contact with one of said surfaces (where total internal reflected light is at least partially frustrated).

A digital camera in provided for acquiring an image of the obliquely illuminated biometric feature in contact with the surface.

In the apparatus of the invention, the window surfaces may lie within an angle of 20 degrees of each other. Preferably the window surfaces are parallel to within an angle of 2 degrees of each other, but in another aspect may curved with no radius of curvature less flat than 30 mm. The exposed edge is in the form of a closed curve with the transparent window round or circular in shape.

The non-illuminated edges of the optical window may be selectively coated with absorbing material to reduce stray light that may degrade the quality of the image of the biometric feature.

The non-illuminated edges of the transparent window may have a reflective material to make the illumination more even across the extent of the contacting biometric feature.

The apparatus of the invention may comprise an optical system for forming an intermediate image of the biometric feature which, in turn, is relayed by a following lens so that internal baffling can be used to reduce stray light and thus improve contrast in the image.

This invention also provides a method for acquiring a digital image of a biometric feature. The method comprises: providing an apparatus comprising a transparent optical window having generally spaced apart smooth surfaces and at least one exposed edge formed between the surfaces; a source arranged to introduce radiation into the transparent optical window through the exposed edge; and a digital camera arranged to acquire an image of the transparent optical window, bringing a biometric feature into contact with one of the smooth surfaces of the transparent optical window; introducing radiation from the source into the transparent optical window through the exposed edge so that the radiation propagates between the spaced apart surfaces by total internal reflection and obliquely illuminates the biometric feature; and acquiring via the digital camera an image of the illuminated biometric feature.

The structure, operation, and methodology of the invention, together with other objects and advantages thereof, may best be understood by reading the detailed description in connection with the drawings in which each part has an assigned numeral that identifies it wherever it appears in the various drawings and wherein:

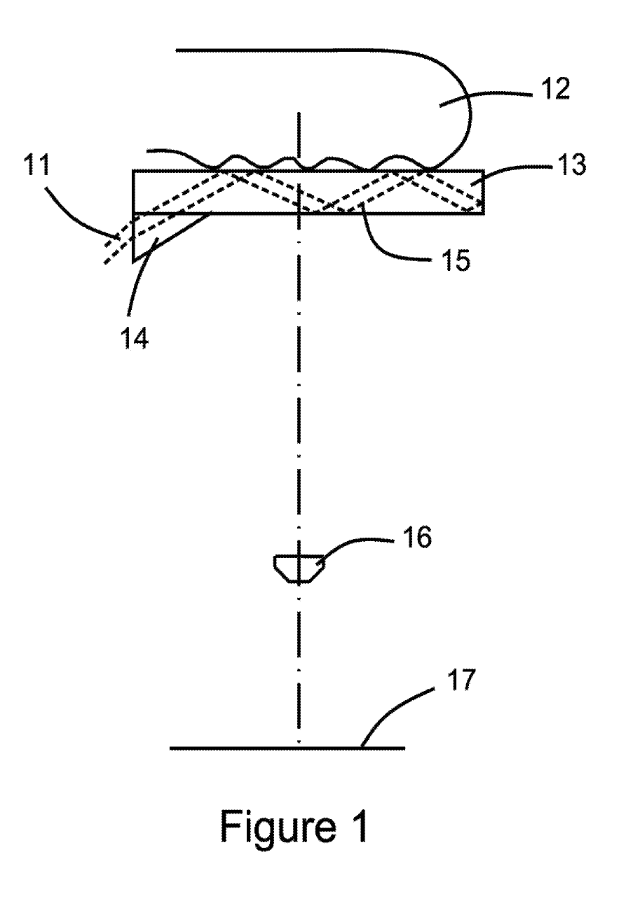

FIG. 1 is a diagrammatic elevational view of a finger placed on a platen which is illuminated through its edge along with a digital camera that records an image of the fingerprint ridges created by obliquely illuminating the finger in contact with the platen;

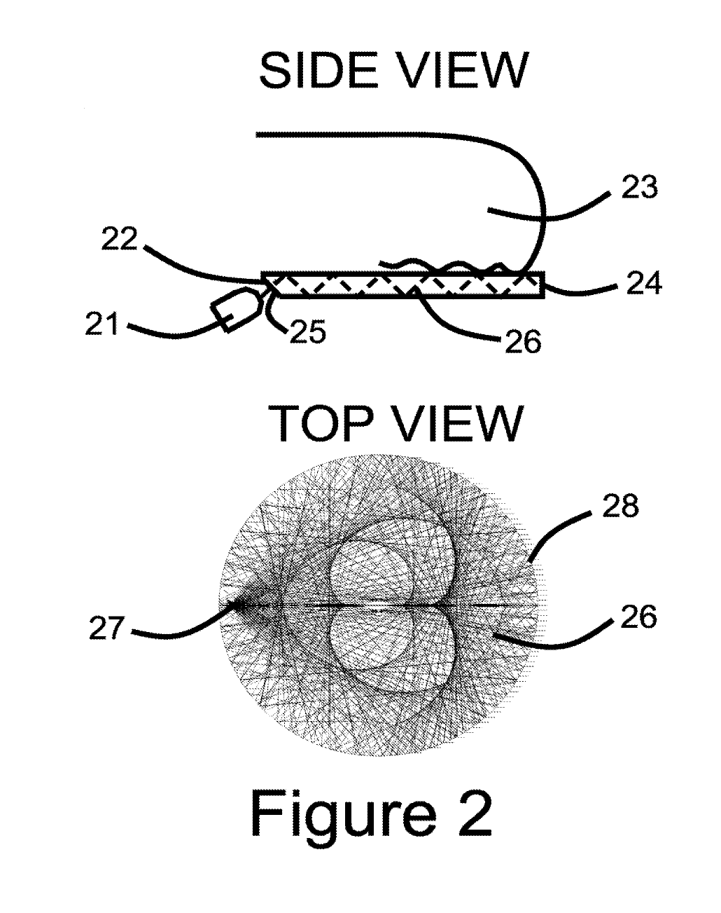

FIG. 2 shows a platen illuminated by a light-emitting diode as seen in side view, and a plot of rays internally reflected by the edges of a round platen as seen from above;

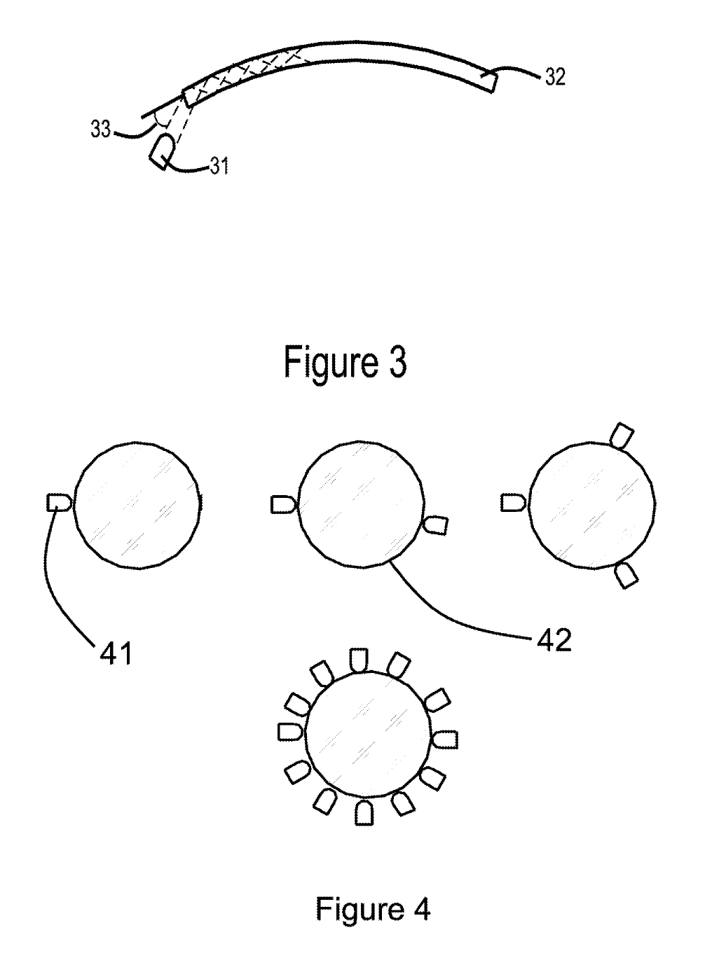

FIG. 3 is a diagrammatic elevational view showing an illuminating light beam entering the edge of the platen at angle sufficient to be internally reflected by the essentially parallel surfaces of the platen;

FIG. 4 is a diagrammatic plan view showing four possible diode locations on the edge of a round platen;

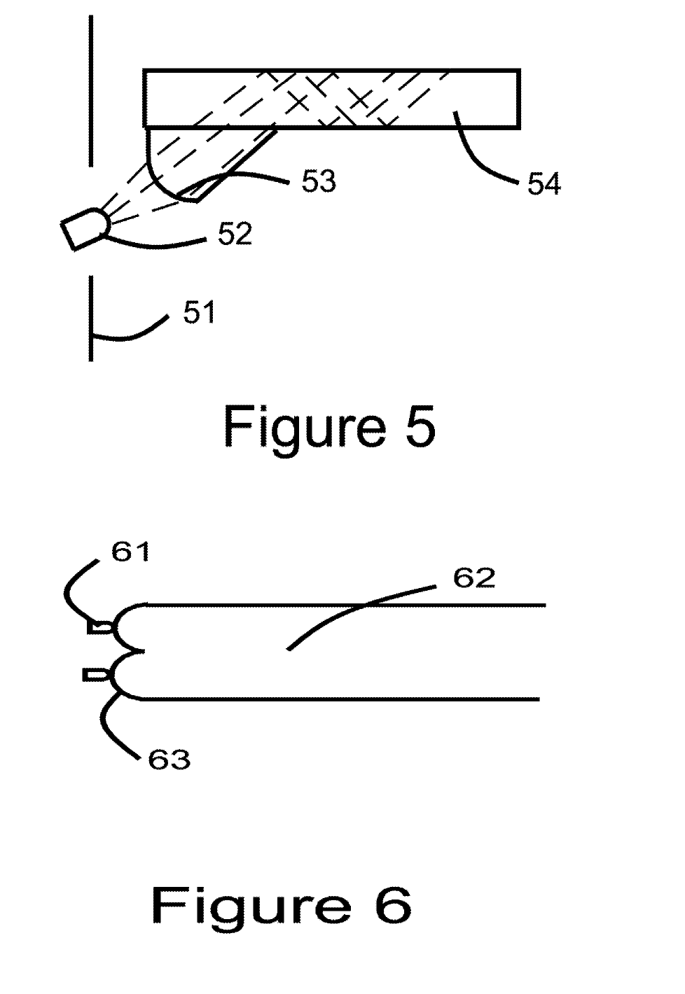

FIG. 5 shows a diode and a collimating lens surface illuminating the surfaces of a platen in accordance with the invention;

FIG. 6 is a diagrammatic side elevational view showing two diodes and corresponding collimating surfaces used to illuminate the surfaces of a platen in accordance with the invention;

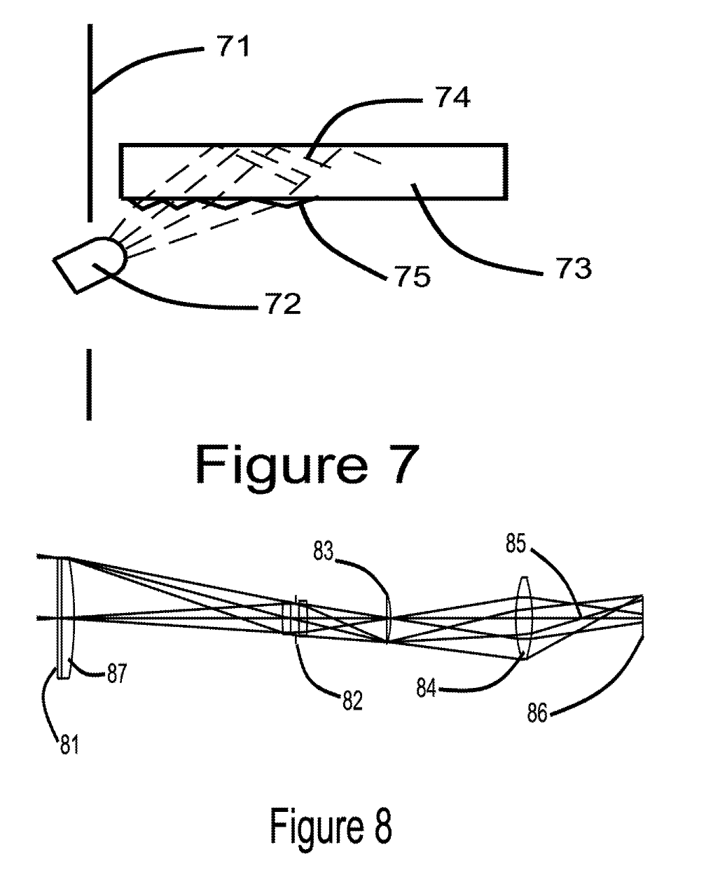

FIG. 7 is a diagrammatic elevational view showing a microprismatic structure on the bottom surface of a platen for collimating the light emitted by a diode for introduction into a platen in accordance with the invention;

FIG. 8 shows a lens relay system forming an intermediate image of the fingerprint ridges onto a field lens that can be baffled for stray light reduction, and a second lens relay to form an image onto the camera sensor;

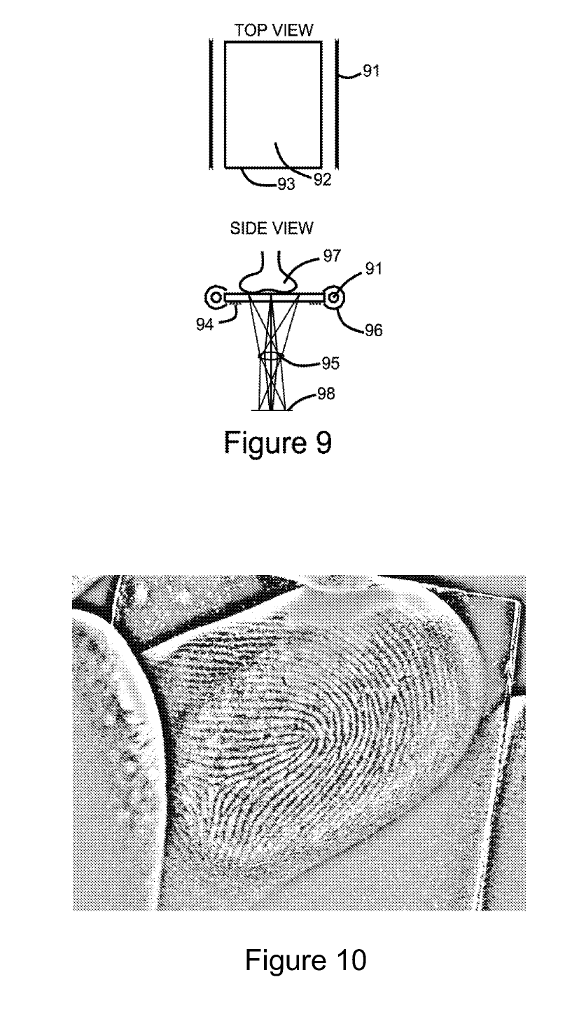

FIG. 9 shows a large platen illuminated by fluorescent tubes, and the placing of a biometric subject on it so that it can be imaged by a camera; and

FIG. 10 is a photograph of biometric image taken in accordance with the invention.

Reference is now made to FIG. 1 which shows a cross sectional, or elevational, view of a finger 12 placed on an essentially parallel surfaced platen 13 or transparent optical window. Light 11 from a diode or other compact light source illuminates the edge of the platen which can in effect be increased by the addition of a small prism 14. Where fingerprint ridges contact the platen 11, the incident illumination lights up the ridges which are then imaged by a lens 16 onto an electronic sensor 17 which can be in the form of a digital camera.

The illuminating source can be a collimating diode 21 as shown in the side or elevational view of FIG. 2 emitting light rays 22 that enter a preferably round platen 24 through a small prismatic notch 25. Afterwards, the light rays 22 are totally internally reflected as shown at 26 by the platen 24 surfaces except where that reflection is frustrated by the optical contact of the ridges of the finger 23 with the platen surface.

As shown in the top view of FIG. 2, the round window 24 has edges 28 which can be used to retro-reflect the light 26 as shown in the top view along paths 26. The incidence angle 33, shown exaggerated in FIG. 3, is made by the line tangent to the surface of a platen 32 and the rays from the source 31.

In FIG. 4, four different diode configurations designated generally at 41 are shown placed at the edge 42 of a round or circular platen.

In FIG. 5, a small prism having a lens surface 53 is attached to a platen 54 so that light from a source 52 is collimated as it enters platen 54. The light source is located on an axis 51 upon which the system can be rotated.

FIG. 6 shows an edge configuration of a platen 62 where more than one light source 61 is employed, and the surface of the edge has facets or small lenses 63.

As shown in FIG. 7, an alternate embodiment is to employ micro-prisms 75 on the lower surface of a platen 73, collimating the light 74 emitted from the source 72. Placing the source on an axis 71 allows for rotation.

Referring now to FIG. 8, there is shown an optical system for forming an intermediate image of a fingerprint which is formed by a relay lens 82 onto a field lens 83 where it can be appropriately baffled and re-imaged by a second relay lens 84 onto a sensor 86. A field lens 87 can be placed near the fingerprint location on the surface of the platen 81 to restrict unwanted light from entering the system, and the exit pupil can be placed outside the second relay lens to further aid in restricting stray light from the sensor 86.

FIG. 9 shows in top and side views an optical system capable of imaging larger biometrics. The top view shows a square flat platen 92, illuminated on two of its flat edges 93 by tubular fluorescent lamps 91 which have shrouds 96 shown in the side view. A biometric object 97 is placed on the platen 92. The surface of the object 97 in contact with the platen 92 is imaged by a lens 95 onto a sensor 98. Black spots 94 are placed on the lower surface of the platen to balance illumination.

Reference is now made to FIG. 10 which shows an actual photograph of a finger print illuminated and imaged in accordance with the teachings of the invention.

The invention as disclosed requires only an ordinary image-forming lens, an ordinary digital sensor, and simple illumination components. An expensive prism as employed in the prior art is replaced by a simple window. The required apparatus can be smaller and cheaper than any previous solutions. Also the invention can be scaled to any desired size, as for an entire hand, and it can be produced with any desired image quality.

We call this solution to the problem of acquiring an image of a biometric “hybrid illumination” because the incident light is oblique and is more or less collimated, as in bright field illumination, but the finger ridge image is viewed by scattered light, as in dark field illumination. Distinct from other contact-method prior art known to the inventors, the viewing angle is direct, so there is no problem with either field tilt or anamorphic distortion.

Because the contact surface to be touched by a finger is a window, rather than a thick prism, special provision must be made for putting in the incident illumination. As shown above, that can be done with a small prism attached with clear optical cement to either side of a transparent window. That prism can be of any convenient size, can carry optical power if desired for improving the state of collimation, can be deployed as a molded Fresnel optical element, or can be molded as part of a one-piece plastic window structure. If more light is desired for a better digital signal, or if more uniform lighting is desired, the incident light can be introduced from more than one side of the window, or from more than one azimuth around the window.

The light introduced into the window bounces multiple times between the two spaced apart surfaces, so if the window is thin enough and the prism is wide enough all parts of the fingerprint area are illuminated. The edges of the window should be blackened to avoid loss of contrast through re-entry of light that has been scattered or deflected from its original angle.

For purposes of illustration, the embodiments shown here may be implemented with a standard VGA sensor having 640×480 square pixels of 8μ spacing, for total dimensions of 5.12×3.84 mm. The image-forming lens may have a focal length of 6.87 mm and an aperture of f/3.8, and may be fabricated with just two plastic lens elements. If the magnification is adjusted to ⅕ from the finger to the sensor, the spacing from the finger to the first principal plane of the image-forming lens will be nominally 41.2 mm, increased by about ⅓ of the window thickness, and the spacing from the rear principal plane to the sensor will be nominally 8.24 mm. The images need not be telecentric on either side of the lens, so many other lenses designed for popular photography may be substituted in this invention. Of course, a more complicated short-focus lens can be designed that would make the system more compact. The sensor array can be any appropriate imaging sensor such as conventional CCD, CID, or CMOS device with enough pixels for the task. Binning techniques or other well-known image post-processing techniques can be used with the invention. A system of this kind can easily be made to meet the FBI's Automatic Fingerprint Identification System (AFIS) standards if that is desired.

The embodiments illustrated may be folded with one or more simple plane mirrors, perhaps between the window and the image-forming lens, to make it even more compact and to orient the window in the most convenient and ergonomic posture for finger contact.

In the case of a PMMA transparent optical window of refractive index 1.492, the angle of incidence of the internal light against the finger contact surface should preferably be at least 63.2°, so that stray water of index 1.333 will not defeat the total reflection. By calculation with Snell's Law that angular requirement will be met if light enters the window through any perpendicular edge with incidence angle 33 less than 42.3°, shown most simply in FIG. 3. The light source is assumed to be far enough away so that all of its illumination enters the window at about the same angle:

Because the measured refractive index of a human finger is about 1.51, slightly in excess of the 1.492 assumed here for the window, any internal angle of incidence greater than 63.2° will work for present purposes. But extreme angles will reduce the efficiency of illumination onto the finger where the ridges touch the window, through both awkward foreshortening geometry and Fresnel reflection losses. If a window material is selected with a high refractive index, the angle of incidence onto the internal window surface must be kept lower than the critical angle for internal reflection where the finger ridges touch the window.

LED's can be used to illuminate the window, and there are many possible configurations, including any number of sources. The embodiment in FIG. 3 employs a reflective edge, but other edge geometries have advantages. The reflective edge in this picture occurs in all locations where the LEDs are not coupling light into the window. Other methods for stray light suppression are also mentioned later, notably methods to blacken edges and suppress stray light are discussed. The location of such features are implemented in locations that do not block source light being coupled into the window.

Although this simple edge illumination can be used, the cost of the window can be reduced if it does not require an optically finished edge. For this advantage and to make the apparatus more compact, light may be introduced with the help of a small glass or plastic prism as shown in FIG. 5 for example.

The prism face that receives the light may be convex to collimate the light within the window, at least in the section illustrated.

Out of this plane, the surface may have the same curvature, so that the light is collimated in both axes. It may alternatively be straight, or in fact the surface may be part of a toroid of revolution about Axis A, perpendicular to the window and passing through the light source. In this last case, all light within the window will strike its large faces at the same angle, but the beam will be spreading with distance from Axis A, and will therefore appear less bright at window positions farther from that axis. The gradient of illumination across the finger pad can easily be compensated by installing a plurality of such prisms onto the window at angular intervals around the finger contact area, in a manner similar to sources shown in the previous FIG. 4 with a top-down view of the window face.

Each prism is attached to the window surface with a clear material, such as a common lens cement, that has a high enough refractive index to avoid light loss by reflection at the boundary. All optical bonding operations mentioned in this invention follow this basic assumption unless otherwise noted.

Molding technologies allow for complex edge detail at low cost. There are many possible types, including facets and microstructures. The methodology for this coupling of light into the side of the window is to create an angular distribution of light from sources that sufficiently illuminate the fingerprint-side of the window with internal light confined in the window, including multireflections. Such features can be molded directly into the window or can be components that are attached to the window with an optical cement or with a clear pressure sensitive adhesive (or with optical bonding techniques discussed in the previous paragraph).

Prisms or lens-prisms that can be used to get illumination into the window at the desired angle of incidence may also be implemented as an unusual kind of “Fresnel” lens, or echelon lens, to be cheaply molded in plastic, either as part of the window itself or in the form of thin components to be attached to the window with an optical cement or with a clear pressure sensitive adhesive.

FIG. 7 illustrates one special form of Fresnel lens that could be used for introducing the light. For convenience, we can suppose that it is made as a figure of revolution about Axis 71, passing through a light source and perpendicular to the window plate 74, but the structure of it out of this sectional plane could alternatively be straight, or of some other form.

The optical facets of the Fresnel lens are of two types, alternating radially outward from the Axis 71. The facets facing and catching the light are preferably slightly convex in this section, but acceptably may be flat, and are shaped and tilted to collimate their received light individually and collectively at the desired angle into the window plate. Facets farther from the light source will be a little flatter than those closer, and will be progressively tipped a little more parallel to the window to maintain the desired collimation. The individual curvatures and tilts of these facets can be calculated easily by one of ordinary skill in lens design, and allowance can be made if the Fresnel lens material has a refractive index slightly different from that of the window plate.

Because the paired facets form a series of small ridges the structure can be quite compact. The features needed can be fabricated with known methods of cutting a plastic or non-ferrous metal master with a sharp diamond tool, using equipment commercially available from Precitech or from Moore Tool, as well as other possible suppliers. It is standard art to make such Fresnel lenses and their associated molding tools for high-volume manufacture. The molding tools may be made as an electroformed nickel replica of a prototype plastic lens, for example, or may be cut directly with a sharp diamond tool in plated nickel with a sufficiently high phosphorous content. Either kind of tool is suitable for volume production of the optical parts by familiar means such as casting, compression molding, transfer molding, injection molding, or ultrasonic stamping.

The facets that are here drawn nearly edge-on to the radiating path of the light are ideally made exactly so, to minimize either loss of light or an undesired redirection of light by oblique surface reflections from such facets so that it enters the window at any angle different from the selected one.

As in the case of the toroidal prism face considered above, the Fresnel lens described here will provide an extended beam of light into the window in such a way that all of the light striking the window surfaces, even after reflections therefrom, will be maintained at the angle selected, even as the light spreads with distance from Axis 71.

A molded plastic Fresnel lens of this type used for introducing collimated light into the window may be made small and local, or it may continue as a featureless cemented flat lamina across the entire window, beyond the extent of the tilted optical facets. Or the Fresnel lens or lenses can be molded together with the window itself as a single object.

A important aspect of the present disclosure is teaching that insertion of light into a window, when restricted to a range of angles that will result in total internal reflection, followed by multiple reflections of that light from both surfaces of the window, enables the convenient optical imaging of detailed contact properties of a fingerprint ridge structure over an extended area. This enabling feature applies especially to areas with dimensions even much greater than the thickness of that window. The foregoing discussion of prismatic or multi-faceted prismatic optical components is intended only to describe a means of introducing light into a window so that it can be made thin if desired and does not necessarily require special window-edge preparation.

Light that has reflected multiple times in this way from the window surfaces will have moved laterally across the window area, and will be expected to reflect or scatter eventually from window edges, support brackets, and any other prisms or Fresnel lens structures that are present to introduce light from additional azimuths. Part of such light will be expected further to strike the window surface at an undesirably small angle if it ever bounces back to the finger, and may then reduce the image contrast by illuminating the structural valleys. In addition to absorbing ink or paint (or aforementioned reflective coating) on the window edges, and preferably on any extraneous facets of the attached prisms, the image quality can benefit from inclusion of a weak non-scattering absorbing dye within the window itself, or within a thin layer on one or both sides of the window plate itself. For this benefit, the dye concentration should preferably be adjusted to absorb about half of the light in a full trip across one diameter of the viewing area of the window, in order to reduce its presence to an acceptable lower level after subsequent trips back across the area. Support brackets and mechanical features of all kinds should have stray light suppressing dark surfaces, and preferably should be designed to contact the window in minimal areas.

The finger structure itself scatters about 50% of red light striking it, but reflects less green light or blue light. The valleys between the ridges in the finger surface structure will not appear totally dark under the hybrid illumination and direct viewing technologies disclosed here, but receive some light by repeated diffusion inward and laterally from the ridges in contact with the window, through the skin and underlying flesh. Although red LED's are cheaper than others, the darkness of the valleys and hence fingerprint image contrast may be improved simply by choosing a different color of illumination, such as green or blue, that is more absorbed by the underlying flesh; or if white light is more convenient to provide, then a green or blue filter can be placed in the optical path before the sensor.

Normally the apparatus will be positioned to avoid unnecessary light received through the finger contact window from extraneous sources, but it is expected that the finger or other object will adequately block undesired illumination over the area of interest. Further improvement may be made by introducing a color filter within the image optical path to favor the intentional illumination over stray ambient illumination. In a severe operating location a dark shroud or screen of some sort can be placed behind the finger as a protective baffle.

An additional means of reducing undesirable stray light is to employ a telecentric field stop and field lenses.

The first surface of the window upon which the finger is placed can also be slightly curved to aid in ergonomic finger placement approximately centered on the optical axis. This will also assure that the window is covered by the finger, thus avoiding possible stray light. The inside of the window can also be mildly curved for optical purposes, provided the conditions for TIR are still suitably satisfied to avoid parasitic stray light that reduces contrast.

Any background light that might pass by the finger, and get directly to the lens and sensor would reduce the signal/noise, and could wash out the image. The above illustrated embodiment is telecentric in the space with the window (object-telecentric). Background illumination would likely be from a relatively distant source, but only a significant amount of light at very small angles would actually get through the imaging lens. Sources of light at off-axis distant points would not get through the imaging system of the invention. Furthermore, if a spot is placed at the telecentric stop, then the distant rays on axis, where the most light could get through would be blocked. Further enhancements to the image quality at the low spatial frequency can be realized by employing spatial filtering techniques at the stop (namely in the image Fourier plane).

Another method to reduce stray light is to form an intermediate image, and place a field stop at or near that location (FIG. 8). If further a field lens is employed, the aperture stop is reimaged. This can be accessible either in a relay lens, or external to it. Additionally, apodizing or spatial filtering devices can be employed at either the stop or its image to further enhance contrast and reduce effects of undesirable stray light.

For convenient functioning, this apparatus may be turned on and off electrically as needed by sensing the mechanical pressure of an applied finger, perhaps by means of a resilient window support or overall support, and a microswitch. Alternatively, an oscillating electric field may be established around the apparatus such that finger contact can be detected by a change in electrical capacitance, or conductance, with respect to ground, as a means of activating the illumination, image sensing, and data processing circuits. Such means are commonly used as a novelty to turn table lamps on and off.

A plastic contact window may be protected by a tough transparent coating, such as that provided by Swedlow Dow Corning in the form of a cured polymer loaded with a high percentage of small inorganic particles, without loss of function, provided only that the average refractive index of the coating is not low enough to cause total reflection back into the window at the chosen angle of collimation. Alternatively, a veneer of glass may be applied to the exposed surface where a finger will touch it. The window itself may also be made of glass for robust environmental conditions where access control is required.

The use of hybrid illumination to permit image formation by contact of a finger or hand against a surface under conditions of total reflection has some limitations. Perhaps the most serious of these is the problem found with a large feature, such as the palm of the hand, contacted against a thin window. By the time light reaches the center of the feature it has reflected several or many times from both surfaces of the window. Reflection at the air surface is not a problem, as no energy is lost, but significant light is lost through scatter at every reflection from the window surface where the feature is in optical contact with it. Near the center of the pattern, or the area farthest from the injection of light, illumination on the feature may fall below a desired level due to the losses along the way, and in any case the amount of light near that central area will be dependent upon the amount of feature contact elsewhere. An image of the feature obtained through the window may be corrected locally for illumination level by conventional means such as “dodging”, or a gentle and smoothly varying adjustment of the measured range of densities, but only at the expense of dynamic range in the imaging system.

This illumination problem with a large biometric feature can also be solved by using a thicker window. In the extreme, the window may be thought of as a large cube, in which the injected light can reach all parts of the biometric feature without additional reflection from a possible contact area. The image formed through such a thick object can easily be photographed or imaged electronically with a lens of conventional design, allowing only for minor adjustments to its aberration balance. At high resolution and reasonable numerical aperture the dominant image aberration found with a thick window will be lateral color, and we have determined that this particular aberration is easy to cancel in the use of an off-the-shelf lens simply by putting another (much thinner) flat window of appropriate thickness in the space between the lens and the film or sensor array. Alternatively, the problem can be avoided by restricting the spectral bandwidth with the use of a color filter somewhere in the optical system.

This illumination problem can also be improved greatly by injecting additional light into the window at angles much more oblique than the critical angle, and even more oblique than the 63.2° suggested previously to allow total reflection against a wet window surface. Provided that the window material has a lower refractive index than that of the ridges or protrusions on the biometric feature, measured to be about 1.51, even the most oblique light traveling laterally across the window has the potential to enter and scatter from that feature. Window materials of slightly higher index, including most inexpensive glasses and such common clear plastics as polystyrene and polycarbonate, will still function to provide an image of contacted areas of the biometric feature, but with some slight waste of light at the very most oblique angles.

When light is injected into the window from one or more of its edges, what we prefer to avoid is injecting light that will strike the biometric contact area with angles of incidence anywhere within a cone defined by the critical angle at that surface; the critical angle is the arcsine of the reciprocal refractive index of the window material. Light within the cone of critical angle is undesired because it can pass through the window surface and illuminate non-contacting areas of the biometric feature, leading to a reduction in contrast in the image of the (bright) protruding ridges and other structures contacting the window.

If the window is thick enough, the above requirements can be met by fabricating the window with a smooth, non-scattering perimeter edge, nearly perpendicular to its surface, and providing that edge in one or more places with sources of light. Such sources may be tungsten bulbs, light-emitting diodes, fluorescent tubes, “neon” sign tubing, or xenon flash tubes. The light sources are ideally placed close to the window edge, but not optically contacted to it with oil, glue, or other material that would allow light to enter the window other than by refraction through the smooth perpendicular edges. Under these conditions of illumination, light entering the window will span a range of internal angles, but cannot quite reach the critical angle for illumination of the biometric contact surface for any window material of refractive index greater than about \sqrt{2}, or 1.414. All useful plastic and glass window materials have an index greater than this value, so the condition will be easy to meet.

Unwanted light from the sources may be masked with reflective material, either diffuse or specular, as may be needed to contain it, but preferably without the use of adhesive materials against the window surfaces or edges. These features may be included in methods to collimate a given light source for coupling into the window as described in this invention.

In the simplest system of this kind, there will be a gradual loss of light with progressive distance from each source, so some system balancing may be desired. That can be accomplished by applying an optically contacted absorbing material, such as black paint, to local areas of either flat window surface in the vicinity of the light sources. The absorption there will selectively attenuate the steeper (less oblique) light striking the window, and will therefore selectively darken the areas of biometric feature contact farther from the center of the window. The most oblique light from the edge sources may reach the central part of the biometric feature with no prior window reflections, or only a few, and all of those taking place distant from the selectively darkened edge. The paint can be applied in a sparse pattern of small dots so that the local area density can be controlled accurately and so that the painted area will not cast a shadow artifact onto the biometric feature.

Methods to collimate light sources can include use of lenses, mirrors or other optics, and can be separate from the light source, window, or integrated or attached to them. These elements can also include anamorphic or toroidal optics for the purpose of creating different angular light beam profiles at different azimuths entering the window by the described methods in this invention.

Light sources need not surround the entire window area. With a suitable window shape and light source positions, internal reflections from the unlighted edges may extend the apparent sizes of the light sources and thereby achieve adequate uniformity if illumination over the needed biometric contact area. In this example (See FIG. 9 for example), a window of 9″ by 6″ of 0.5″ thick window glass is lighted on its two long edges by slim FA100 fluorescent tubes, running the full length of the edges. A suitable tube with diameter less than ½ inch is sold by Westek in their Ultra Light 13″ fluorescent cabinet light. It draws 8 Watts.

The short edges provide internal reflections that make the illumination uniform up to the ends of the window. (Mirrors could be attached here, or coated onto the glass edge, but they are not needed.) The light sources and the immediately adjacent window edges are shrouded by sheet metal baffles that contain the excess light, keeping it out of the image-forming optical system. Some dots of black paint are indicated schematically to show where they might be placed to balance illumination between the edges and center of the biometric contact area:

As before, the use of a flat window permits the use of a conventional form of image lens, with suitable adjustment if necessary for the slight aberrations introduced by the window. No correction is needed for distortion with this arrangement.

Ideally an access control device to be installed in or next to a door should have a round housing to allow insertion in a drilled hole. To obtain the benefits TIR without use of a rectangular prism, the finger is placed on a transparent window, which is illuminated at an angle exceeding the angle of TIR, and the TIR is frustrated by the ridges of the fingerprint. Illuminating the edge of the window provides the required illumination. By utilizing edge illumination the optical axis is perpendicular to the object surface where the finger is placed, thus allowing the use of conventional imaging lenses without any distortion due to a tilting object, and the sensor is also perpendicular to the optical axis, allowing for ease of assembly and focusing.

Another feature of the invention is that because by its very nature, access control is limited to a relatively small data base of recorded fingerprints (for verification). Hence the round entrance window does not need to be as large as a finger. In fact, when the entire fingerprint is on record, the entrance window can have a diameter of ten millimeters or less. This reduces the possibility of stray light entering outside the edge of the finger because the finger can cover the window.

A further feature of the invention is that in-line optical path allows for efficient baffling of stray light from the window, or if the finger is not centered on the window. The mechanical housing may contain light trapping features such as threading, vanes, baffles, rough-blackened surfaces, paints, and other methods commonly used to suppress stray light. Finally, the system requirement for TIR illumination provided at the entrance widow allows for many different illumination designs, including different light sources, number of lamps, position of lamps, and edge details which can be incorporated interchangeably.

It will be understood by those skilled in the relevant arts that the term “lens” is used to mean either of both refractive and/or reflective optical surface powers, and the use of reflective surfaces does not depart from the invention.

1. An apparatus for acquiring a digital image of a biometric feature, said apparatus comprising:
a transparent optical window having generally spaced apart smooth surfaces and at least one exposed edge formed between said surfaces;
a source for introducing radiation into said transparent optical window through said exposed edge so that the radiation coupled through said exposed edge propagates between said spaced apart surfaces by total internal reflection to obliquely illuminate a biometric feature when brought into contact with one of said surfaces; and
a digital camera for acquiring an image of the obliquely illuminated biometric feature in contact said one surface.

2. The apparatus of claim 1 wherein said source comprises one or more light emitting diodes.

3. The apparatus of claim 2 wherein said light emitting diodes are selected from the group comprising red, green, blue, and white illumination.

4. The apparatus of claim 1 wherein the window surfaces lie within an angle of 20 degrees of each other.

5. The apparatus of claim 1 wherein the window surfaces lie within an angle of 2 degrees of each other.

6. The apparatus of claim 1 wherein said spaced apart surfaces are parallel.

7. The apparatus of claim 1 wherein said window surface contacted by the biometric feature is curved with no radius of curvature less flat than 30 mm.

8. The apparatus of claim 1 wherein said exposed edge is in the form of a closed curve.

9. The apparatus of claim 8 wherein said transparent optical window is generally circular in shape.

10. The apparatus of claim 1 wherein the largest dimension of said transparent window is less than 20 mm.

11. The apparatus of claim 1 wherein the largest dimension of said transparent window is 9 mm or less.

12. The apparatus of claim 1 wherein said window surfaces are free of microstructures.

13. The apparatus of claim 1 wherein the non-illuminated edges of said optical window are selectively coated with absorbing material to reduce stray light that may degrade the quality of the image of the biometric feature.

14. The apparatus of claim 1 wherein the non-illuminated edges of said transparent window have a reflective material to make the illumination more even across the extent of the contacting biometric feature.

15. The apparatus of claim 1 further including comparator for comparing said image with prior registered images to allow controlled personal access to a locked room, enclosure, or electronic equipment.

16. The apparatus of claim 1 where a subset of the biometric feature is utilized.

17. The apparatus of claim 1 wherein a lens is placed near said transparent window to direct light from the biometric feature into the pupil of the camera lens.

18. The apparatus of claim 1 wherein the camera lens is comprised of an intermediate image and relay lens to re-image said intermediate image onto the camera sensor.

19. A method for acquiring a digital image of a biometric feature, the method comprising:
providing an apparatus comprising a transparent optical window having generally spaced apart smooth surfaces and at least one exposed edge formed between the surfaces; a source arranged to introduce radiation into the transparent optical window through the exposed edge; and a digital camera arranged to acquire an image of the transparent optical window,
bringing a biometric feature into contact with one of the smooth surfaces of the transparent optical window;
introducing radiation from the source into the transparent optical window through the exposed edge so that the radiation propagates between the spaced apart surfaces by total internal reflection and obliquely illuminates the biometric feature; and
acquiring via the digital camera an image of the illuminated biometric feature.
